(19) United States
(12) Patent Application Publication
(10) Pub. No.: US 2010/0134401 A1
(43) Pub. Date: Jun. 3, 2010

(54) Liquid Crystal Display and Method of Driving the Same

(76) Inventors: Seung-Woon Shin, Asan-Si (KR); Young-Ki Kim, Hwasung-si (KR); Sung-Woon Im, Asan-si (KR); Jun-Ho Hwang, Asan-si (KR)

Correspondence Address: F. CHAU & ASSOCIATES, LLC, 130 WOODBURY ROAD, WOODBURY, NY, 11797, US

(21) Appl. No.: 12/468,380

(22) Filed: May 19, 2009

(30) Foreign Application Priority Data
Dec. 1, 2008 (KR) 10-2008-0120518

(51) Int. Cl. G09G 3/36

(52) U.S. Cl. 345/99

(57) ABSTRACT

A liquid crystal display (LCD) and a method of driving the LCD are provided. The LCD includes a display panel; and a timing controller providing a first data signal to the display panel during a first frame period, a second data signal to the display panel during a second frame period and a blank signal to the display panel during a blank period between the first and second frame periods, wherein the voltage of the blank signal varies among a plurality of levels between the voltage of the first data signal and the voltage of the second data signal.

### CROSS-REFERENCE TO RELATED APPLICATION

This application claims priority from Korean Patent Application No. 10-2008-0120518 filed on Dec. 1, 2008 in the Korean Intellectual Property Office, the contents of which are herein incorporated by reference in their entirety.

### BACKGROUND OF THE INVENTION

1. Field of the Invention

The present disclosure is directed to a liquid crystal display (LCD) and a method of driving the LCD, and more particularly, to an LCD and a method of driving the LCD, which can improve display quality and can reduce audible noise.

2. Description of the Related Art

Liquid crystal displays (LCDs) generally include a first display panel having a plurality of pixel electrodes, a second display panel having a common electrode, and a liquid crystal layer interposed between the first and second display panels and having dielectric anisotropy. The pixel electrodes are arranged in a matrix having a plurality of pixel electrode rows and a plurality of pixel electrode columns and are connected to a plurality of switching devices such as thin-film transistors (TFTs). Thus, the pixel electrode rows are sequentially provided with a data voltage. The common electrode is formed on the entire surface of the second display panel and is provided with a common voltage. The pixel electrodes, the common electrode and the liquid crystal layer may form a plurality of liquid crystal condensers. The liquid crystal condensers form the basic elements of pixels along with a plurality of switching devices connected thereto.

An LCD may display a desired image by application of a data voltage to the pixel electrodes and a common voltage to the common voltage to generate an electric field between the pixel electrodes and the common electrode, and adjustment of the intensity of the electric field to control the amount of light transmitted through the liquid crystal layer. To prevent image deterioration resulting from applying an electric field to the liquid crystal layer in one direction for an extended period of time, the polarity of a data voltage with respect to a common voltage may be inverted in units of frames, pixels, pixel rows, or pixel columns.

Due to an increasing size of LCDs and an increasing signal frequency transmitted by LCDs, a rapid change in the data voltage polarity may result in an insufficient time to charge the liquid crystal capacitors with a target voltage, which may cause a deterioration of display quality.

In addition, if a data voltage applied to each pixel rapidly changes, a current through each data line may also rapidly change, causing a multi-capacitor for generating a driving voltage to quickly charge and discharge and possibly vibrate due to a piezo effect. When the multi-capacitor vibrates, a printed circuit board (PCB) on which the multi-capacitor is mounted may also vibrate, thereby causing audible noise.

### SUMMARY OF THE INVENTION

Aspects of the present invention provide a liquid crystal display (LCD) which can improve display quality and reduce audible noise.

Aspects of the present invention also provide a method of driving an LCD, which can improve display quality and reduce audible noise.

However, the aspects and features of embodiments of the present invention are not restricted to the ones set forth herein. The above and other aspects and features of embodiments of the present invention will become more apparent to one of ordinary skill in the art to which the present invention pertains by referencing a detailed description of the present invention given below.

According to an aspect of the present invention, there is provided an LCD including: a display panel; and a timing controller providing a first data signal to the display panel during a first frame period, providing a second data signal to the display panel during a second frame period and providing a blank signal to the display panel during a blank period between the first and second frame periods, wherein the voltage of the blank signal varies among a plurality of voltage levels between a voltage of the first data signal and a voltage of the second data signal.

According to another aspect of the present invention, there is provided a method of driving an LCD, the method including: providing a first data signal to a display panel during a first frame period, providing a second data signal to the display panel during a second frame period and providing a blank signal to the display panel during a blank period between the first and second frame periods; and varying a voltage of the blank signal a plurality of voltage levels between a voltage of the first data signal and a voltage of the second data signal.

### BRIEF DESCRIPTION OF THE DRAWINGS

FIG. 1 illustrates a block diagram of a liquid crystal display (LCD) according to an exemplary embodiment of the present invention.

FIG. 2 illustrates an equivalent circuit diagram of a pixel of a display panel for the embodiment shown in FIG. 1.

FIG. 3 illustrates a diagram for explaining a frame period and a blank period.

FIG. 4 illustrates a block diagram of a timing controller for the embodiment shown in FIG. 1.

FIG. 5 illustrates a block diagram of an image-signal processor for the embodiment shown in FIG. 4.

FIG. 6 illustrates a diagram for explaining how to apply a data voltage corresponding to a frame signal and a data voltage corresponding to a blank signal.

FIG. 7 illustrates a block diagram of a data driving module for the embodiment shown in FIG. 1.

### DETAILED DESCRIPTION OF THE EXEMPLARY EMBODIMENTS

Embodiments of the present invention will now be described more fully with reference to the accompanying drawings, in which exemplary embodiments of the invention are shown. The invention may, however, be embodied in many different forms and should not be construed as being limited to the embodiments set forth herein. It will be understood that when an element is referred to as being “connected” or “coupled” to another element, it can be directly connected or coupled to the other element or intervening elements may be present. Like numbers refer to like elements throughout.

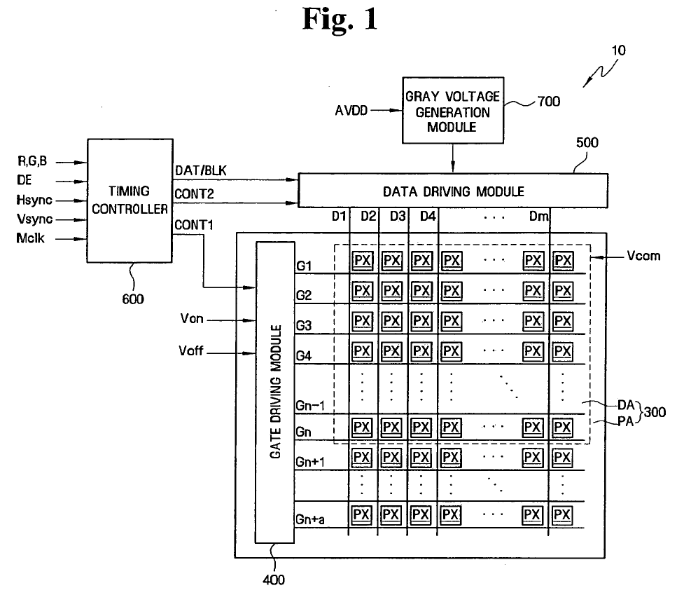

A liquid crystal display (LCD) and a method of driving the LCD, according to exemplary embodiments of the present invention, will hereinafter be described in detail with reference to FIGS. 1 through 7.

Referring to FIG. 1, an LCD 10 may include a display panel 300, a timing controller 600, a gate driving module 400, a data driving module 500, and a gray voltage generation module 700.

The display panel 300 may include a plurality of pixels PX, which are formed at the interconnections between a plurality of gate lines G₁ through Gₙ₊ₐ and a plurality of data lines D₁ through Dₘ. The display panel 300 may be divided into a display area DA in which an image is displayed and a non-display area PA in which no image is displayed.

The display area DA may include a first substrate (not shown) on which the gate lines G₁ through Gₙ, the data lines D₁ through Dₘ, a plurality of switching devices (not shown), and a plurality of pixel electrodes (not shown) are formed, a second substrate (not shown) on which a plurality of color filters (not shown) and a common electrode (not shown) are formed, and a liquid crystal layer (not shown) which is interposed between the first substrate and the second substrate. The gate lines G₁ through Gₙ may extend in a row direction in parallel with one another. The data lines D₁ through Dₘ may extend in a column direction in parallel with one another.

The non-display area PA may include a first substrate on which the gate lines Gₙ₊₁ through Gₙ₊ₐ, the data lines Gₙ₊ₐ, a plurality of switching devices and a plurality of pixel electrodes, a second substrate, and a liquid crystal layer interposed between the first and second substrates. Since no image is displayed in the non-display area PA, the second substrate of the non-display area may not include any color filters.

The pixels PX may be arranged in a matrix having a plurality of pixel rows and a plurality of pixel columns. The pixel rows may be respectively connected to the gate lines G₁ through Gₙ₊ₐ, and the pixel columns may be respectively connected to the data lines D₁ through Dₘ.

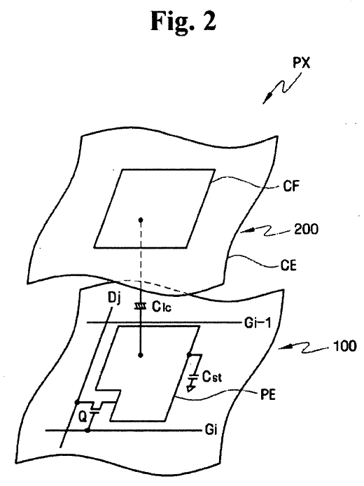

Referring to FIG. 2, a color filter CF may be formed on a portion of a common electrode CE on a second substrate 200 to face a pixel electrode PE on a first substrate 100. For example, a pixel PX, which is connected to an i-th gate line Gᵢ (1≦i≦n) and a j-th data line Dⱼ (1≦j≦m), includes a switching device Q connected to the i-th gate line Gᵢ and the j-th data line Dⱼ, and a liquid crystal capacitor C_{lc} and a storage capacitor Cₛₜ which are both connected to the switching device Q. The storage capacitor Cₛₜ may be optional.

Referring to FIG. 1, a common voltage Vcom may be applied to the common electrode CE by a voltage provider (not shown), and a data voltage may be applied to the pixel electrode PE through the data lines D₁ through Dₘ by the data driving module 500. The liquid crystal capacitor C_{lc} may display an image by being charged with a voltage corresponding to the difference between the common voltage Vcom and the data voltage.

The voltage provider (not shown) may generate a gate-on voltage Von, a gate-off voltage Voff, and the common voltage Vcom, may provide the gate-on voltage Von and the gate-off voltage Voff to the gate driving module 400, and may provide the common voltage Vcom to the common electrode CE.

The timing controller 600 may receive a primitive image signal (red (R), green (G), and blue (B)) and a plurality of external control signals (Vsync, Hsync, Mclk and DE) for controlling the display of the primitive image signal (R, G, and B), and may output a data signal DAT, a blank signal BLK, a gate control signal CONT1 and a data control signal CONT2.

More specifically, the timing controller 600 may receive the primitive image signal (R, G and B) and may output a data signal DAT and a blank signal BLK. The timing controller 600 may receive the external control signals (Vsync, Hsync, Mclk and DE) and may generate the gate control signal CONT1 and the data control signal CONT2. The external control signals (Vsync, Hsync, Mclk, and DE) include a vertical synchronization signal Vsync, a horizontal synchronization signal Hsync, a main clock signal Mclk, and a data enable signal DE. The gate control signal CONT1 is a signal for controlling the operation of the gate driving module 400, and the data control signal CONT2 is a signal for controlling the operation of the data driving module 500.

The timing controller 600 may provide a data signal DAT during a frame period, and may provide a blank signal BLK during a blank period.

More specifically, the timing controller 600 may provide a first data signal DAT1 to the display panel 300 during a first frame period, may provide a second data signal DAT2 to the display panel 300 during a second frame period and may provide a blank signal BLK to the display panel 300 during a blank period between the first and second frame periods.

The voltage of a blank signal BLK may vary between the voltage of the first data signal DAT1 and the voltage of the second data signal DAT2. For example, if the voltage of the first data signal DAT1 is higher than the voltage of the second data signal DAT2, the voltage of the blank signal may gradually decrease. On the other hand, if the voltage of the first data signal DAT1 is lower than the voltage of the second data signal DAT2, the voltage of the blank signal may gradually increase. The first and second data signals DAT1 and DAT2 may have different polarities. The timing controller 600 will be described below in further detail.

The gate driving module 400 may receive the gate control signal CONT1 from the timing controller 600 and may sequentially provide a gate signal to the gate lines G₁ through Gₙ. The gate signal may be the combination of the gate-on voltage Von and the gate-off voltage Voff.

The gate driving module 400 may be formed in the non-display area of the display panel 300 and may be connected to the display panel 300. However, embodiments of the present invention are not restricted to this. That is, the gate driving module 400 may be implemented as an integrated circuit (IC) formed as a tape carrier package (TCP). The gate driving module 400 is illustrated in FIG. 1 as being disposed on one side of the display panel 300, but embodiments of the present invention are not restricted to this. That is, the gate driving module 400 may include first and second gate drivers disposed on either side of the display panel 300.

The gray voltage generation module 700 may generate a data voltage by dividing a driving voltage AVDD according to the grayscale of a data signal DAT. The gray voltage generation module 700 may include a plurality of resistors connected in series between a ground and a node to which the driving voltage AVDD is applied. Thus, the gray voltage generation module 700 may generate a plurality of gray voltages by divide the driving voltage AVDD. However, the structure of a gray voltage generation module according to embodiments of the invention is not restricted to that set forth herein.

The data driving module 500 may receive the data control signal CONT2 from the timing controller 600 and may apply a data voltage corresponding to a data signal DAT and a blank voltage corresponding to a blank signal BLK to the data lines D₁ through Dₘ. The data voltage and the blank voltage may be originally provided by the gray voltage generation module 700.

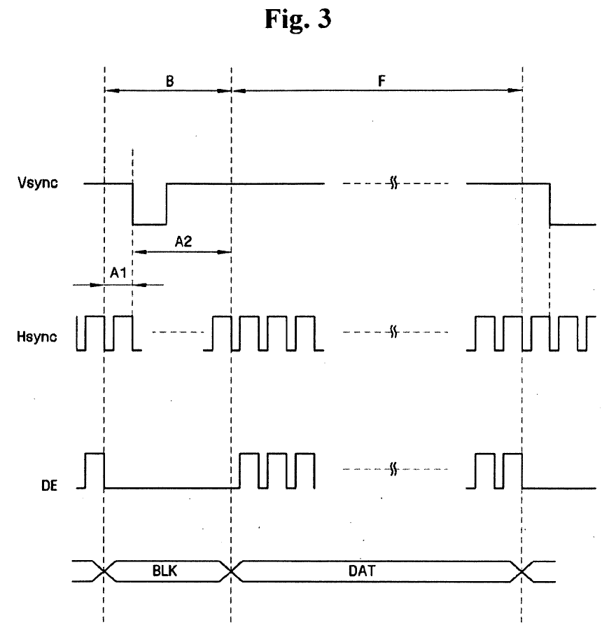

Referring to FIG. 3, the operation period of the timing controller 600 may be classified into a frame period F and a blank period B. The period of the vertical synchronization signal Vsync is a frame, and the period of the horizontal synchronization signal Hsync is a pixel row. The data enable signal DE may indicate the input of a data signal corresponding to each of the pixels PX.

The blank period B may include a first blank period A1 between the time when the output of the data enable signal DE is complete and the time when the vertical synchronization signal Vsync is switched to a first level, for example, a low level, and a second blank period A2 between the time when the vertical synchronization signal Vsync is switched to the first level and the time when the frame period F begins, i.e., the time when a data signal DAT is applied to a first pixel row. The blank period B may be provided between a plurality of frame periods F.

As described above, the timing controller 600 may provide a data signal DAT during the frame period F and may provide a blank signal BLK during the blank period B.

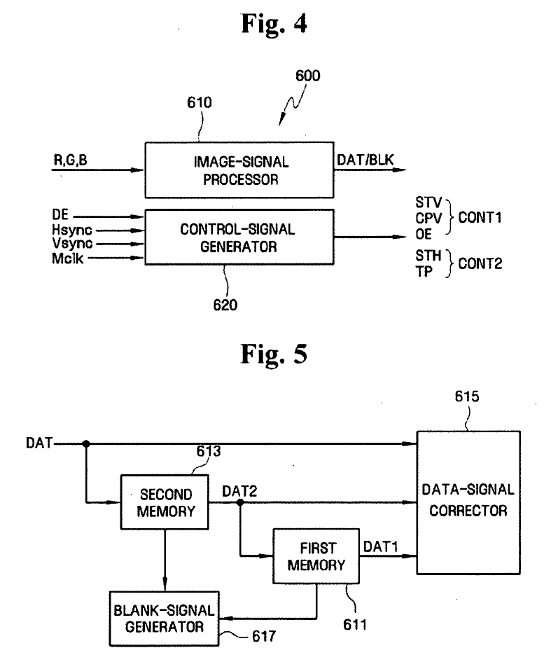

Referring to FIG. 4, the timing controller 600 may include the image-signal processor 610 and a control-signal generator 620.

The image-signal processor 610 may receive the primitive image signal (R, G and B) and may output a data signal DAT and a blank signal BLK. More specifically, the image-signal processor 610 may output the first data signal DAT1 during a first frame period, may output the second data signal DAT2 during a second frame period and may output a blank signal BLK during a blank period between the first and second frame periods.

The image-signal processor 610 may provide the first and second data signals DAT1 and DAT2 and a blank signal BLK to each of a plurality of pixel columns so that a number of pixels PX included in each of the pixel columns can have the same polarity. That is, the pixels PX may be driven using a pixel-column inversion driving method.

A data signal DAT may be corrected to improve display quality. For this, a data signal of a previous frame may be stored in a memory. The memory may be used to generate a blank signal BLK, and this will be described later in further detail with reference to FIG. 5.

The control-signal generator 620 may receive the external control signals (Vsync, Hsync, Mclk and DE) and may generate the gate control signal CONT1 and the data control signal CONT2. The gate control signal CONT1 is a signal for controlling the operation of the gate driving module 400. The gate control signal CONT1 may include a vertical initiation signal STV for initiating the operation of the gate driving module 400, a gate clock signal CPV for determining when to output the gate-on voltage Von, and an output enable signal OE for determining the pulse width of the gate-on voltage Von. The data control signal CONT2 is a signal for controlling the operation of the data driving module 500. The data control signal CONT2 may include a horizontal initiation signal STH for initiating the operation of the data driving module 500 and an output instruction signal TP for initiating the output of a data voltage.

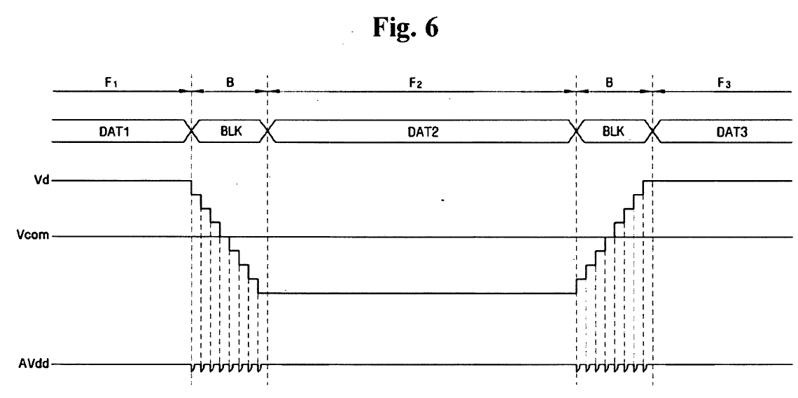

Referring to FIGS. 5 and 6, the image-signal processor 610 may include a first memory 611 which stores the first data signal DAT1, a second memory 613 which stores the second data signal DAT2, and a blank-signal generator 617 which is provided with the voltages of the first and second data signals DAT1 and DAT2 by the first and second memories 611 and 613 and generates a blank signal BLK.

To improve the response speed of the pixels PX, the image-signal processor 610 may also include a data-signal corrector 615. The data-signal corrector 615 may correct a data signal DAT. For example, the data-signal corrector 615 may perform dynamic capacitance compensation (DCC) on a data signal DAT. The data-signal corrector 615 may be provided with the first and second data signals DAT1 and DAT2 by the first and second memories 611 and 613. That is, the blank-signal generator 617 and the data-signal corrector 615 may share the first and second memories 611 and 613 with each other. Thus, there is no need to provide additional memory for storing data signals necessary for generating a blank signal BLK.

Referring to FIG. 6, the first data signal DAT1 may be provided during a first frame period F₁, the second data signal DAT2 may be provided during a second frame period F₂, and a third data signal DAT3 may be provided during a third frame period F₃. A d BLK may be provided during a blank period B between the first and second frame periods F₁ and F₂ and during a blank period B between the second and third frame periods F₂ and F₃.

For example, the pixels may be classified into first through (n+a)-th pixel rows. The first through third data signals DAT1 through DAT3 may be sequentially applied to each of the first through n-th pixel rows, and a blank signal BLK may be applied to the (n+1)-th through (n+a)-th pixel rows. A data signal DAT may correspond to a voltage applied to each of the pixels PX and may include n sub-data signals (not shown) respectively corresponding to the first through n-th pixel rows. For example, if the pixels PX are driven using a pixel-column inversion driving method, a data signal DAT and a blank signal BLK may be applied to each of the pixel columns. That is, the first through third data signals DAT1 through DAT3 may be provided to one of the pixel columns during the first through third frame periods F₁ through F₃.

The voltage of a blank signal BLK may vary between the voltage of the first data signal DAT1 applied to the n-th pixel row and the voltage of the second data signal DAT2 applied to the first pixel row. For example, if a voltage of 7 V is applied to the n-th pixel row as the first data signal DAT1 and a voltage of −7 V is applied to the first pixel row as the second data signal DAT2, the voltage of the blank signal BLK may gradually decrease in stages.

The interval and number of stages by which the voltage of a blank signal BLK varies may be arbitrarily determined. For example, referring to FIG. 6, the voltage of a blank signal BLK may sequentially vary, at regular intervals of time, from a first to an eighth level that are evenly spaced within a predetermined voltage range. The amount of time for which the voltage of the blank signal BLK is maintained at each of the first through eighth levels may be uniformly maintained. That is, during a blank period B, the first through eighth levels may be sequentially provided to each of the pixels PX for the same amount of time.

In short, the blank-signal generator 617 may determine the voltage of the blank signal BLK based on the voltage of the first data signal DAT1 applied to the n-th pixel row and the voltage of the second data signal DAT2 applied to the first pixel row. The blank-signal generator 617 may be provided with the voltage of the first data signal DAT1 applied to the n-th pixel row and the voltage of the second data signal DAT2 applied to the first pixel row by the first and second memories 611 and 613. The image-signal processor 610 is illustrated in FIG. 5 as including the first and second memories 611 and 613, the data-signal corrector 615 and the blank-signal generator 617, but embodiments of the present invention are not restricted to this. That is, not all of the first and second memories 611 and 613, the data-signal corrector 615 and the blank-signal generator 617 may be included in the image-signal processor 610.

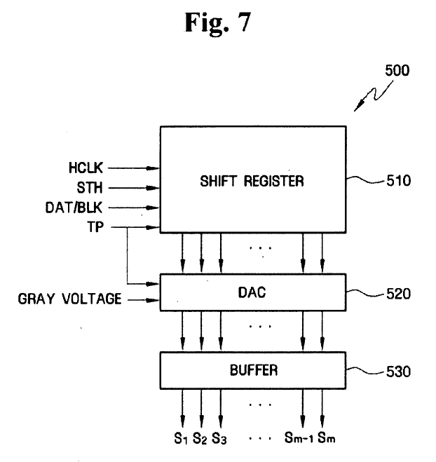

Referring to FIG. 7, the data driving module 500 may receive a data signal DAT and a blank signal BLK and may generate a plurality of data voltage signals S₁ through Sₘ. The data driving module 500 may include a shift register 510, a digital-to-analog converter (DAC) 520, and a buffer 530.

The shift register 510 may sample a data signal DAT and a blank signal BLK in response to the horizontal initiation signal STH. More specifically, the shift register 510 may sequentially sample a data signal DAT and a blank signal BLK in response to the horizontal initiation signal STH and a data clock signal HCLK, and particularly, in response to a rising edge of the horizontal initiation signal STH. The data driving module 500 may include a plurality of sub-data drivers (not shown). In this case, if the first sub-data driver finishes sampling a data signal DAT and a blank signal BLK, the first sub-data driver may transmit a carry-out signal to the second sub-data driver.

Once the sampling of a data signal DAT and a blank signal BLK is complete, the shift register 510 may output the sampled data signal DAT and the sampled blank signal BLK to the DAC 520 at the same time in response to a load signal TP, and particularly, in response to a rising edge of the load signal TP.

The DAC 520 may receive the sampled data signal DAT and the sampled blank signal BLK from the shift register 510, and may output an analog data signal corresponding to the sampled data signal DAT and the sampled blank signal BLK. More specifically, the DAC 520 may generate an analog data signal corresponding to the sampled data signal DAT and the sampled blank signal BLK based on a gray voltage provided by the gray voltage generation module 700 and may provide the analog data signal to the buffer 530 in response to, for example, a falling edge of the load signal TP.

The buffer 530 may buffer the analog data signal and may provide the data voltage signals S₁ through Sₘ using the buffered analog data signal. More specifically, the buffer 530 may choose polarity for the analog data signal and may provide the analog data signal having the chosen polarity to the data lines D₁ through Dₘ of the display panel 300 as the data voltage signals S₁ through Sₘ in response to a reverse signal RVS (not shown).

Referring to FIG. 6, a data voltage Vd is applied to each of the pixels PX in response to each of the data voltage signals S₁ through Sₘ. A data voltage Vd corresponding to the first data signal DAT1 and a data voltage Vd corresponding to the second data signal DAT2 may have different polarities. In addition, a data voltage Vd corresponding to the second data signal DAT2 and a data voltage Vd corresponding to the third data signal DAT3 may have different polarities. For example, if the data voltage corresponding to the first data signal DAT1 is positive, the data voltage Vd corresponding to the second data signal DAT2 may be negative, and the data voltage Vd corresponding to the third data signal DAT3 may be positive. The terms ‘positive’ and ‘negative’ may be relative terms describing the polarity of the data voltage Vd with respect to the common voltage Vcom. A data signal DAT and a blank signal BLK may be applied to each of the pixel columns, and a positive voltage signal and a negative voltage signal may be alternately provided as the data signal DAT. That is, the pixels PX may be driven using a pixel-column inversion driving method.

During the first frame period F₁, a positive data voltage Vd may be applied to first through n-th pixels in an arbitrary pixel column. During a blank period B following the first frame period F₁, a plurality of voltages, which are arranged in descending order and are evenly spaced within a predetermined voltage range, may be applied to each of (n+1)-th through (n+a)-th pixels in the arbitrary pixel column. Since the data voltage Vd is generated based on the driving voltage AVDD, a variation in the data voltage Vd may cause ripples in the driving voltage AVDD. Therefore, the data voltage Vd may be gradually increased or decreased in stages during a blank period B, thereby reducing ripples in the data voltage Vd.

The eighth level of a blank signal BLK may be the same as the voltage of a data signal DAT following the blank signal BLK. More specifically, the eighth level of the blank signal B applied between the first and second data signals DAT1 and DAT2 may be the same as a data voltage Vd applied to the first pixel row as the second data signal DAT2. In this case, if the data voltage Vd is applied to the first pixel row, no ripples may be generated. Accordingly, the time taken to charge the first pixel row with the data voltage Vd may be the same as the time taken to charge any one of the second through n-th pixel rows with the data voltage Vd.

According to embodiments of the present invention, it is possible to reduce ripples in a driving voltage by varying a voltage of a blank signal among a plurality of levels during a blank period between a pair of adjacent frame periods. In addition, it is possible to reduce fluctuations in the driving voltage caused by rapid changes in a data voltage. That is, it is possible to reduce audible noise caused by a driving voltage generator.

While embodiments of the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A liquid crystal display (LCD) comprising:
a display panel; and
a timing controller providing a first data signal to the display panel during a first frame period, providing a second data signal to the display panel during a second frame period and providing a blank signal to the display panel during a blank period between the first and second frame periods,
wherein a voltage of the blank signal varies among a plurality of voltage levels evenly spaced between a voltage of the first data signal and a voltage of the second data signal.

2. The LCD of claim 1, wherein:
if the voltage of the first data signal is higher than the voltage of the second data signal, the voltage of the blank signal gradually decreases; and
if the voltage of the first data signal is lower than the voltage of the second data signal, the voltage of the blank signal gradually increases.

3. The LCD of claim 1, wherein the first and second data signals have different polarities.

4. The LCD of claim 1, wherein:
the display panel includes a plurality of pixels arranging in a matrix having a plurality of pixel rows and a plurality of pixel columns;
the first data signal, the blank signal and the second data signal are provided to each of the pixel columns; and
the pixel columns are driven using a pixel-column inversion driving method wherein a number of pixels included in each of the pixel columns can have the same polarity.

5. The LCD of claim 4, wherein:
the pixel rows include first through n-th pixel rows which are sequentially provided with the first or second data signal; and
the timing controller determines the voltage of the blank signal based on a voltage applied to the n-th pixel row as the first data signal and a voltage applied to the first pixel row as the second data signal.

6. The LCD of claim 5, wherein:
the timing controller includes a first memory storing the first data signal and a second memory storing the second data signal; and
the timing controller is provided with the voltage applied to the n-th pixel row as the first data signal and the voltage applied to the first pixel row as the second data signal by the first and second memories.

7. The LCD of claim 5, wherein the timing controller performs dynamic capacitance compensation (DCC) using the first and second data signals wherein a response speed of the pixels is improved.

8. The LCD of claim 5, wherein the time taken to charge the first pixel row with the voltage of the second data signal is the same as the time taken to charge any one of the second through n-th pixel rows with the voltage of the second data signal.

9. The LCD of claim 1, wherein each of the plurality of voltage levels of the blank signal are provided to the display panel for the same amount of time during the blank period.

10. A method of driving a liquid crystal display (LCD), the method comprising:
providing a first data signal to a display panel during a first frame period, providing a second data signal to the display panel during a second frame period and providing a blank signal to the display panel during a blank period between the first and second frame periods; and
varying a voltage of the blank signal among a plurality of voltage levels between a voltage of the first data signal and a voltage of the second data signal.

11. The method of claim 10, comprising:
if the voltage of the first data signal is higher than the voltage of the second data signal, gradually decreasing the voltage of the blank signal; and
if the voltage of the first data signal is lower than the voltage of the second data signal, gradually increasing the voltage of the blank signal.

12. The method of claim 10, wherein the first and second data signals have different polarities.

13. The method of claim 10, wherein:
the display panel includes a plurality of pixels arranged in a matrix having a plurality of pixel rows and a plurality of pixel columns; and
providing the first data signal, the blank signal and the second data signal comprises providing the first data signal, the blank signal and the second data signal to each of the pixel columns and driving the pixel columns using a pixel-column inversion driving method wherein a number of pixels included in each of the pixel columns has the same polarity.

14. The method of claim 13, wherein:
the pixel rows include first through n-th pixel rows which are sequentially provided with the first or second data signal; and
providing the blank signal comprises determining the voltage of the blank signal based on a voltage applied to the n-th pixel row as the first data signal and a voltage applied to the first pixel row as the second data signal.

15. The method of claim 14, wherein determining the voltage of the blank signal comprises receiving the voltage applied to the n-th pixel row as the first data signal from a first memory and receiving the voltage applied to the first pixel row as the second data signal from a second memory.

16. The method of claim 14, wherein the time taken to charge the first pixel row with the voltage of the second data signal is the same as the time taken to charge any one of the second through n-th pixel rows with the voltage of the second data signal.

17. The method of claim 10, wherein the plurality of voltage levels of the blank signal are evenly spaced between the voltage of the first data signal and the voltage of the second data signal.

18. A liquid crystal display (LCD) comprising:
a display panel; and
a timing controller providing a first data signal to the display panel during a first frame period, providing a second data signal to the display panel during a second frame period and providing a blank signal to the display panel during a blank period between the first and second frame periods,
wherein a voltage of the blank signal varies among a plurality of voltage levels between a voltage of the first data signal and a voltage of the second data signal, wherein each of the plurality of voltage levels of the blank signal are provided to the display panel for the same amount of time during the blank period.

19. The LCD of claim 18, wherein the plurality of voltage levels of the blank signal are evenly spaced between the voltage of the first data signal and the voltage of the second data signal.
